(19) United States
(12) Patent Application Publication
(10) Pub. No.: US 2007/0039131 A1
(43) Pub. Date: Feb. 22, 2007

(54) Pop-up hinge with leaf spring

(75) Inventor: Edward Rude, Columbia, MD (US)

Correspondence Address: GOTTLIEB RACKMAN & REISMAN PC, 270 MADISON AVENUE, 8TH FLOOR, NEW YORK, NY, 100160601, US

(73) Assignee: Torqmaster, Inc.

(21) Appl. No.: 11/472,658

(22) Filed: Jun. 22, 2006

Related U.S. Application Data
(60) Provisional application No. 60/708,656, filed on Aug. 16, 2005.

(51) Int. Cl. E05F 1/08

(52) U.S. Cl. 16/277

(57) ABSTRACT

A hinge that provides an inexpensive way for achieving a large and controllable pop-up for a case (e.g., those used for laptop computers, automotive center consoles, briefcases, and the like) and that does not lead to distortion of the case or failure from the gradual relief of stresses stored in the materials of the case or the hinge. The hinge employs a spring comprised of a beam. The design allows different spring forces for the different phases of motion. A first phase, the pop-up phase, is accomplished by the leaf spring formed from the hinge material itself. A second phase, in which continued upward force of a reduced magnitude is sufficient during the further opening of the lid, may be provided by an optional helper spring which can be one of the many types that have traditionally been used with hinges. The advantage of the multiple spring arrangement is that the leaf spring provides a very high spring force for the pop-up action over a short range of motion, while a much lower force with an appropriate spring rate can be provided for the remainder of the angular opening excursion.

### RELATED APPLICATION

This application claims the priority of U.S. provisional application Ser. No. 60/708,656 filed on Aug. 16, 2005.

### FIELD OF THE INVENTION AND BACKGROUND

The term ‘pop-up’ is used in the context of a laptop case, automotive center console, automotive overhead compartment door or any similar case that is held closed by some form of latch mechanism, and which opens slightly upon release of the latch. The opening occurs as a result of some form of spring energy stored in the case when it is closed.

The pop-up function of the prior art has been accomplished in a crude fashion by configuring a hinge to reach its limit in the closing direction a few degrees before the lid is completely closed and the latch engages. In the few degrees of further motion that is required for the latch to close, some bending and distortion, albeit within the elastic limits of the structure and its components, are required for the latch to close. This further motion requires the application of an external force, a push by the user. This can be accomplished by including a mechanical stop of some sort, or simply by designing the case and hinge structure so that the hinge is at its limit slightly before the latch engages. This approach works, but it usually does not provide the degree of pop-up action that is desired. Furthermore, if the design is such that the distortion of the metal and plastic parts is increased in an effort to achieve a larger pop-up, it is found that there is actually a gradual decrease in pop-up action. The reason is that since a laptop or other plastic case spends a significant part of its lifetime with the lid closed and latched, the plastic of the case gradually deforms to relieve the stored stresses, and the pop-up decreases or disappears altogether.

Another prior art approach has been to use a spring in the hinge itself or elsewhere near the hinge axis to produce the lifting force necessary to cause the lid to pop up when the latch is released. This can work well enough, but it does require the addition of a spring and a suitable pocket for it in a part of the laptop or case that is usually rather constricted.

No matter which approach is taken to produce the lifting force, a frequently encountered problem with lids that pop-up upon release of a latch is that the force required to lift the lid during the pop-up phase is larger than the force that is necessary for the remainder of the opening motion. The use of a single spring, as has been the prior art approach, fails because the spring must apply sufficient force for the pop up action and still have residual force at the end of the 90 or more degrees of opening. With a single spring, the spring rate is such that the force at mid travel (45 degrees or more) is still high and often pops the lid to the fully opened position. Thus, a solution which incorporates a spring system with only one spring rate fails to adequately solve the problem.

### OBJECTS AND SUMMARY OF THE INVENTION

It is an object of our invention to provide an inexpensive method for achieving a large and controllable pop-up for a case (e.g., those used for laptop computers, automotive center consoles, briefcases, and the like) that does not lead to distortion of the case.

It is another object of our invention to provide a hinge for various types of cases that does not fail from the gradual relief of stresses stored in the materials of the case or the hinge.

It is another object of our invention to provide a hinge mounting that can be made much stiffer than those of the prior art so that there is little stress in the plastic material when the case is closed.

It is still another object of our invention to provide different spring forces to satisfy the needs of the different phases of hinge motion.

The basic hinge of our invention comprises two plates hinged together. One of the plates has a leaf spring formed in it, the leaf being bent to face the opposing plate (or some opposing feature of the material to which said plate is attached or an element resting on said plate). The leaf is preferably in the form of a tapered beam so that the stresses are distributed evenly along the length of the spring. The free end of the leaf bears against the other plate when the hinge is closed. It is also possible to form such a leaf spring in each of the plates with the springs facing each other.

In another embodiment, the two plates are hinged together on a pin and a helper spring, which can be one of the many types that have traditionally been used with hinges, is mounted so as to apply forces that tend to open the hinge. For example, a torsion spring can be mounted on the pin with its ends bearing against the plates to apply forces that tend to open the hinge. This design produces different spring forces for the different phases of motion. The first phase, the pop-up phase, is accomplished primarily by the leaf spring formed from the hinge material itself. The second phase, in which continued upward force of a reduced magnitude is sufficient during the further opening of the hinge, is provided primarily by the second spring. The advantage of our multiple spring arrangement is that the leaf spring provides a very high spring force for the pop-up action over a short range of motion, and a much smaller force with an appropriate spring rate can be provided by the helper spring for the remaining large angular opening excursion.

### BRIEF DESCRIPTION OF THE FIGURES

Further objects, features and advantages of our invention will become apparent upon consideration of the following detailed description in conjunction with the drawings, which consist of the following figures.

FIG. 1 is a perspective view of an embodiment of the hinge of our invention that illustrates the operation of the leaf spring which provides the pop-up action. It is shown in the open position. In this embodiment, the tapered leaf spring is a part of the upper element.

FIG. 2 is a side view of the hinge of FIG. 1, but the hinge is shown closed to the degree that the tapered leaf spring is just coming into contact with the opposing hinge plate.

FIG. 3 is also a side view of the same hinge, but now in a fully closed position.

FIG. 4 is a perspective view of another embodiment of the invention in which the tapered leaf spring is a part of the lower element. This embodiment also incorporates a torsion spring to assist in further opening of the device beyond the action of the leaf spring.

FIG. 5 is a perspective view of another embodiment of the invention in which both elements have tapered leaf springs formed as a part thereof. In this embodiment, the torsion spring has been omitted.

FIG. 6 is a perspective view of an embodiment of the invention that is similar to that of FIG. 4, but with the tapered leaf spring in a different orientation, showing that various orientations of the leaf spring are possible.

FIG. 7 is a further variation of the hinge of FIGS. 4 and 6 in which the tapered leaf spring is cut into the edge of the lower hinge plate rather than being further from the edge.

FIG. 8 is a variation on the design of the hinge of FIG. 4 depicting an alternative method to achieve the tapering of the leaf spring.

FIG. 9 shows a variation of the hinge of FIG. 4 in which a finger formed in the upper element is used to contact the leaf spring so that the pop-up action can take place at an angle different from that of the fully closed position of the hinge, for example, as shown in this view, at ninety degrees.

### DETAILED DESCRIPTION OF THE INVENTION

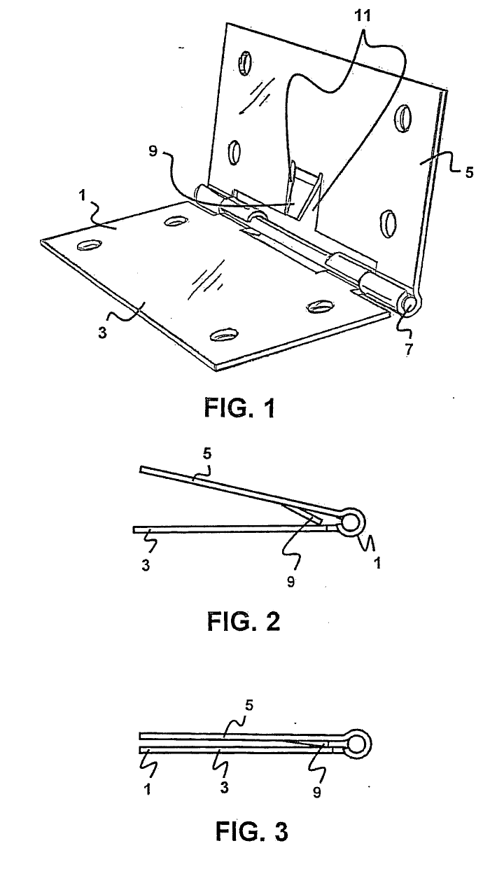

Referring to FIG. 1, hinge 1 is comprised of plate 3, plate 5, and pin 7. Each plate is formed with members 8 that are wrapped around pin 7 for hinging action in the usual manner of butt hinges. Each plate can have stamped mounting holes 10 for attachment to whatever case or other device is being hinged. Plate 5 has a tapered finger or leaf spring 9 formed by removing material to form slots 11. This would usually be done as a part of the forming of the plate in a stamping die. Tapered finger 9 is bent inward so that it will contact plate 3 before the hinge reaches a completely closed position.

The hinge is normally made of spring steel, high-carbon heat-treated steel being preferable but not essential. But other spring-like materials can be used, for example, glass-filled plastic and Lexan. Pin 7 is preferably made of case-hardened steel.

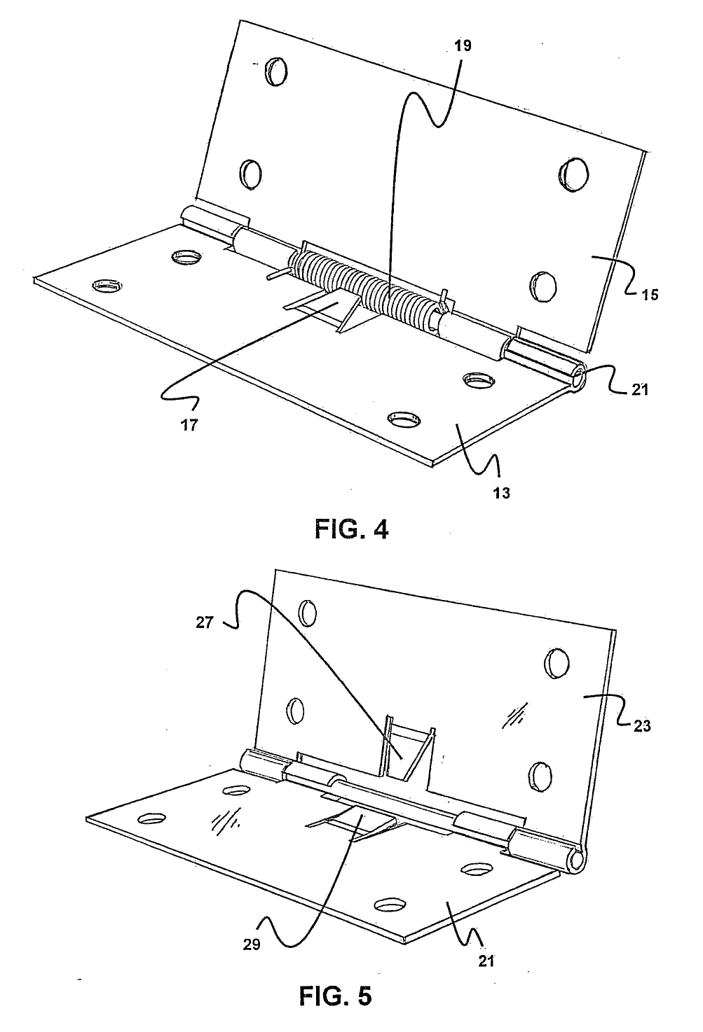

In FIG. 2, the same hinge is shown in a side view with the hinge closed to the point at which tapered finger 9 just comes into contact with plate 3. Alternatively, if a torsion spring is provided around pin 7 (see FIG. 4 for example), finger 9 may be shifted axially so as to come into contact with the tang of the torsion spring. Other similar stop means may be provided without departing from the inventive concept.

In FIG. 3, the hinge is still further closed, bending tapered finger 9. If finger 9 were not tapered, the bending stresses would be concentrated at the root of the finger, where it joins the body of plate 5. By tapering the finger, the bending stresses can be distributed along the length of the finger, making it possible to achieve a larger deflection without exceeding the elastic limit of a moderately hard spring material.

The hinge of FIG. 4 has bottom plate 13 with tapered finger or leaf spring 17 and top plate 15 with no finger. Thus, in accordance with the invention, the finger can be formed in either plate. FIG. 4 also shows a further improvement in our inventive hinge, namely, the inclusion of torsion spring 19 around shaft 21. The torsion spring can be designed to provide any desired amount of lifting torque to assist in the opening of the lid of the case in which the hinge is used. Through the initial opening, the pop-up phase, both tapered finger 17 and the torsion spring 19 provide torque. Since the torsion spring and the tapered finger operate independently, the manufacturer of the hinge has a great deal of freedom in choosing the optimum spring rate and excursion for both the leaf spring and the torsion spring.

In addition to its weight, many lids include friction that is intentionally provided in the hinge system for the purpose of maintaining the position of the lid when it is open. This situation commonly exists in laptop computers where the viewing angle of the screen is critical and must be maintained. Friction hinges are also included in lids, such as those used for automotive center console compartments. In these situations, friction is included to prevent the lid from accidentally falling down and from slamming shut. Where friction is included in the hinge system, the torque required to open the lid is increased. This creates the need for a torsion spring to assist in opening. By including the torsion spring on the hinge pin, the lifting torque can be increased to any desired amount, and can disappear when the lid reaches the open position.

Referring to FIG. 5, another embodiment is shown in which both bottom plate 21 and top plate 23 have fingers or leaf springs 29 and 27 respectively. For simplicity, no torsion spring is shown, although it is obvious that one could be included. Finger 29 in bottom plate 21 is shown with a different taper than that of finger 27 in top plate 23. The use of fingers in both plates, possibly with differing tapers, provides the hinge designer with a greater range of spring rates and ranges of operation for the pop-up torque of the hinge.

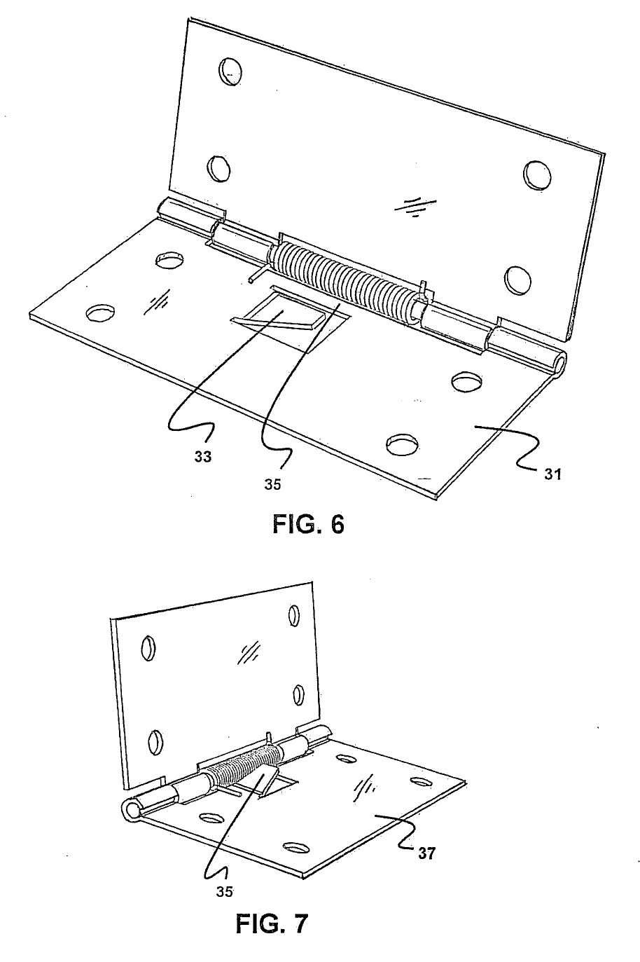

FIG. 6 depicts a hinge with another configuration for the tapered finger. Bottom plate 31 has tapered finger 33 stamped in it. In this case, the tapered finger is oriented perpendicular to those in the previously shown embodiments. In some cases requiring a longer finger, this configuration may offer advantages. Also, in this configuration, web portion 35 of the material of plate 31 remains intact, providing some stiffness to the rear edge of bottom plate 31.

The hinge shown in FIG. 7 has finger 35, also oriented parallel to the hinge pin, cut from the edge of bottom plate 37. While the inner edge of plate 37 has been cut, which may be disadvantageous, the finger can be closer to the axis of the hinge.

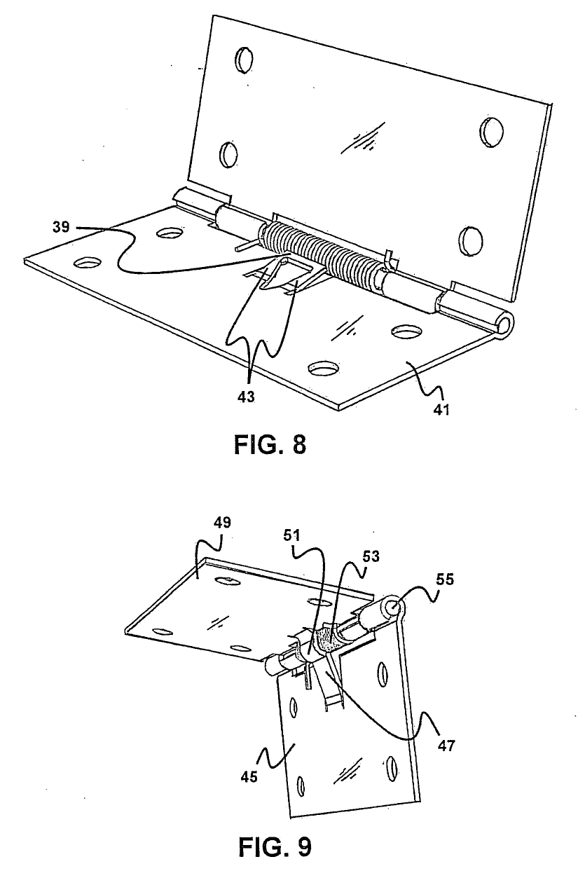

Another configuration for the formation of the tapered finger is shown in FIG. 8, in which finger 39 of bottom plate 41 has two tapered arms 43 bridged together at their ends. With this configuration, the finger can be wider at the area of contact with the other plate, while still providing sufficient taper to distribute the bending stresses.

In the previous embodiments, the pop-up action takes place only from the closed position of the hinge. But it may be advantageous that the pop-up action take place at some other hinge angle. FIG. 9 depicts a method for achieving the benefits of our invention in a hinge in which the two plates are separated in the ‘closed’ position and in which the pop-up action thus takes place when the hinge is already at an open angle. Bottom plate 45 has tapered finger 47 formed in it, as in previous embodiments. Top plate 49 has offset finger 51 which is configured to wrap partially around torsion spring 53 on hinge pin 55. Offset finger 51 is sized so that its free end contacts tapered finger 47 at the required angle at which the pop-up action is to take place. Apart from the change in the starting position, the operation of this hinge can be identical to that of the hinge of FIG. 4.

It should be appreciated why the invention is referred to as a pop-up hinge rather than a pop-open hinge. The spring only ‘works’ at the beginning of hinge opening, and it provides no force after about 5-10 degrees of opening. Thus the spring causes the hinge to pop up, but not to open to a significant degree.

Although the invention has been described with reference to particular embodiments, it is to be understood that these embodiments are merely illustrative of the application of the principles of the invention. Numerous modifications may be made therein and other arrangements may be devised without departing from the spirit and scope of the invention.

1. A hinge comprising two plates hinged together, at least one of the plates having a leaf spring formed therein, said leaf spring being in the form of a beam with a free end that bears against a stop member when the hinge is closed.

2. A hinge in accordance with claim 1 wherein the two plates are hinged together on a pin and further including a second spring mounted so as to apply forces that tend to open the hinge.

3. A hinge in accordance with claim 2 wherein, when the hinge is opened from a closed position, the opening force is first provided primarily by the leaf spring and then primarily by said second spring.

4. A hinge in accordance with claim 3 wherein, when the hinge is opened from a closed position, the leaf spring provides a relatively high force for a pop-up action over a short range of motion of the hinge, and said second spring then provides a relatively small force over the remaining large range of motion of the hinge.

5. A hinge in accordance with claim 1 wherein the two plates are hinged together on a pin and further including a torsion spring mounted on said pin and having ends that bear against said plates to apply forces that tend to open the hinge.

6. A hinge in accordance with claim 5 wherein, when the hinge is opened from a closed position, the opening force is first provided primarily by the leaf spring and then primarily by said torsion spring.

7. A hinge in accordance with claim 6 wherein, when the hinge is opened from a closed position, the leaf spring provides a relatively high force for a pop-up action over a short range of motion of the hinge, and said torsion spring then provides a relatively small force over the remaining large range of motion of the hinge.

8. A hinge in accordance with claim 1 wherein both plates have leaf springs formed therein, each spring being in the form of a tapered beam with a free end facing the other plate when the hinge is closed.

9. A hinge in accordance with claim 1 wherein the two plates are hinged together on a pin by plate fingers that partially extend around the pin, and the leaf spring on one plate contacts a finger on the other plate.

10. A hinge in accordance with claim 9 wherein said leaf spring and finger are so arranged to contact each other when the hinge is at an angle different from that of the fully closed position of the hinge so that pop-up action can take place when the hinge is already at an open angle.

11. A hinge for a laptop or the like comprising two plates hinged together, at least one of the plates having a leaf spring formed therein with a free end that faces the other plate when the hinge is closed, the spring being in the form of a tapered beam so as to distribute stresses evenly along the length of the spring.

12. A hinge in accordance with claim 11 wherein the two plates are hinged together on a pin and further including a second spring mounted so as to apply forces that tend to open the hinge.

13. A hinge in accordance with claim 12 wherein, when the hinge is opened from a closed position, the opening force is first provided primarily by the leaf spring and then primarily by said second spring.

14. A hinge in accordance with claim 13 wherein, when the hinge is opened from a closed position, the leaf spring provides a relatively high force for a pop-up action over a short range of motion of the hinge, and said second spring then provides a relatively small force over the remaining large range of motion of the hinge.

15. A hinge in accordance with claim 14 wherein said second spring is a torsion spring.

16. A hinge in accordance with claim 13 wherein said second spring is a torsion spring.

17. A hinge in accordance with claim 11 wherein both plates have leaf springs formed therein, each spring being in the form of a tapered beam with a free end facing the other plate when the hinge is closed.

18. A hinge in accordance with claim 11 wherein the two plates are hinged together on a pin by plate fingers that partially extend around the pin, and the leaf spring on one plate contacts a finger on the other plate.

19. A hinge in accordance with claim 18 wherein said leaf spring and finger are so arranged to contact each other when the hinge is at an angle different from that of the fully closed position of the hinge so that pop-up action can take place when the hinge is already at an open angle.

20. A hinge in accordance with claim 1, wherein the beam has a non-constant width.

21. A hinge in accordance with claim 20, wherein the beam is tapered.

22. A hinge in accordance with claim 1, wherein the stop member is said other plate.

23. A hinge in accordance with claim 5, wherein the stop member is a part of said torsion spring.
